(19) United States
(12) Patent Application Publication
(10) Pub. No.: US 2017/0173629 A1
(43) Pub. Date: Jun. 22, 2017

(54) COATING FOR INSPECTING THE INTERNAL INTEGRITY OF A STRUCTURE AND VEHICLE INCLUDING SAME

(71) Applicants: AIRBUS GROUP SAS, Blagnac (FR); UNIVERSIDADE DE AVEIRO, Aveiro (PT)

(72) Inventors: Sophie SENANI, PARIS (FR); Sylvere BARUT, Lasserre (FR); Joao TEDIM, Aveiro (PT); Mario FERREIRA, Lisboa (PT); Mikhail ZHELUDKEVICH, Aveiro (PT); Frederico MAIA, Gafanha da Nazaré (PT)

(21) Appl. No.: 15/381,153

(22) Filed: Dec. 16, 2016

(30) Foreign Application Priority Data
Dec. 17, 2015 (EP) 15307037

(51) Int. Cl. B05D 5/00; F16D 66/02; F01D 5/28

(52) U.S. Cl. CPC B05D 5/005; F01D 5/288; F16D 66/02; F05D 2230/90

(57) ABSTRACT

The coating for inspecting the internal integrity of a structure, includes an optically active material, and a coating matrix associated with the optically active material and configured to crack when the matrix receives an impact beyond a preset pressure, the optically active material being visible when such a crack is present.

### CROSS REFERENCE TO RELATED APPLICATIONS

This application claims priority to and the benefit of European Application No. 15307037, filed on 17 Dec. 2015, the disclosure of which is incorporated herein by reference in its entirety.

1. Field

The presently disclosed embodiment relates to a coating serving as a device for inspecting the internal integrity of a structure. It especially applies to the detection of internal damage in an aircraft structure.

2. Brief Description of Related Developments

The current tendency, in the aeronautic field, is to replace structural components made of metal with components made of lighter materials such as carbon-fiber reinforced polymer (CFRP). CFRP has the drawback of having a limited tolerance to damage. A single impact such as could occur during assembly or a maintenance operation can cause substantial internal damage and place the integrity of the structure at risk. The very structure of CFRP means that the damage may not be visible from the exterior, thereby making such damage difficult to detect.

In present-day systems, structural coatings contain pigments, or dye capsules, positioned in the thickness of these coatings. The application of a pressure and/or the corresponding energy to the coating causes capsules to burst freeing the dye or causing pigments to diffuse into the matrix, this making it possible to detect that a shock liable to damage the internal structure has occurred at the place where the color of the pigments or capsules is visible.

However, these systems are complex to manufacture, because any shocks experienced during the manufacture or transport of these formulations are liable to cause capsules to burst or the diffusion of pigments.

In addition, these systems do not allow any type of coating to be used with any type of pigment for reasons of color detectability.

These drawbacks are due to the fact that only the diffusion of color into the coating indicates that an impact has occurred.

### SUMMARY

The presently disclosed embodiment aims to remedy all or some of these drawbacks.

To this end, according to a first aspect, the presently disclosed embodiment relates to a coating serving for inspection of the internal integrity of a structure, which includes:

an optically active material; and

a matrix of the coating, which matrix is associated with the optically active material and configured to crack when said matrix receives an impact beyond a preset pressure, the optically active material being visible when such a crack is present.

The effect of these measures is to make it possible to identify the position of an impact on the structure liable to have caused internal damage to the structure. Specifically, the optically active material only becomes visible after the coating matrix has received an impact greater than a preset pressure, this pressure corresponding to an impact liable to damage the interior of the structure.

The advantages of these measures are:

to allow impacts liable to have caused internal damage to the structure to be detected, including by non-specialist operators; and

to allow use under conditions that are independent of constraints on the optically active material, the latter being revealed only after the matrix has cracked.

In aspects, the matrix of the coating and the optically active material are commingled.

These aspects allow the device to be formed from just one layer positioned on the structure, thereby especially allowing the manufacture of the device to be simplified with respect to an equivalent two-layer device.

In aspects, the optically active material represents between 1% and 10% of the weight of the commingled matrix and material.

In aspects, the matrix of the coating is applied to another layer incorporating the optically active material, which layer is applied directly to the structure, the matrix being fastened to an opposite side of this layer with respect to the structure.

These aspects allow the coating matrix on the one hand and the layer containing the optically active material on the other hand to be designed so that each plays an attributed role: the first cracks at a preset pressure and the other creates a luminous signal.

In aspects, the matrix is opaque.

These aspects allow a optically active material to be continuously implemented, this material being revealed by the breakage of part of the matrix.

In aspects, the optically active material is formed from porous luminescent nanoparticles.

These aspects make it possible for the nanoparticles to fluoresce when they make contact with ultraviolet rays, i.e. when the matrix is cracked and a crack makes contact with the nanoparticles.

In aspects, the nanoparticles are dispersed in a resin.

These aspects make it possible for the nanoparticles to belong to a rigid body that is liable to crack when the matrix cracks. This resin forms the matrix when the matrix and material are commingled.

In aspects, the optically active material is chosen to react to the exposure to ultraviolet rays, the optically active material becoming visible during such an exposure.

These aspects allow the presence of damage to be revealed only in the presence of specific equipment, liable to be operated by maintenance personnel.

In aspects, the optically active material is chosen to react to the exposure to a chemical reaction, the optically active material becoming active during such an exposure.

These aspects allow the presence of damage to be revealed only in the presence of specific equipment, which will possibly be operated by maintenance personnel.

In aspects, the matrix is formed from at least one hybrid organic-inorganic, metal organo-alkoxide precursor to form a sol-gel network.

These aspects allow the preset cracking pressure of the matrix to be better controlled.

In aspects, the porous matrix includes clay particles, the pressure required to crack the porous matrix being a decreasing function of the number of clay particles per unit volume in the matrix.

These aspects make it possible to control the preset cracking pressure of the matrix.

In aspects, the porous matrix is transparent at at least one wavelength of optical activity of the optically active material.

These aspects allow the visibility of the optically active material to be improved.

According to a second aspect, the presently disclosed embodiment relates to a vehicle, at least some of one structure of this vehicle being covered by the device for inspecting the internal integrity of a structure, which device is one subject of the presently disclosed embodiment.

Since the aims, advantages and particular features of the vehicle that is one subject of the presently disclosed embodiment are similar to those of the device that is the other subject of the presently disclosed embodiment, they will not be recalled here.

### BRIEF DESCRIPTION OF THE DRAWINGS

Other advantages, aims and particular features of the disclosed embodiment will become clearly apparent from the following nonlimiting description of at least one particular aspect of the device and vehicle that are subjects of the presently disclosed embodiment, which description is given with regard to the appended drawings, in which:

FIG. 1 schematically shows a first particular aspect of the device that is one subject of the presently disclosed embodiment in cross section;

FIG. 2 schematically shows the first particular aspect of the device that is one subject of the presently disclosed embodiment in cross section;

FIG. 3 schematically shows a second particular aspect of the device that is one subject of the presently disclosed embodiment in cross section;

FIG. 4 schematically shows the second particular aspect of the device that is one subject of the presently disclosed embodiment in cross section; and

FIG. 5 schematically shows one particular aspect of the vehicle that is one subject of the presently disclosed embodiment in perspective.

### DETAILED DESCRIPTION

The present description is given by way of nonlimiting example, each feature of one aspect advantageously being combinable with any other feature of any other aspect. Moreover, each parameter of an exemplary aspect may be implemented independently of other parameters of said exemplary aspect.

It will be noted here that the figures are not to scale.

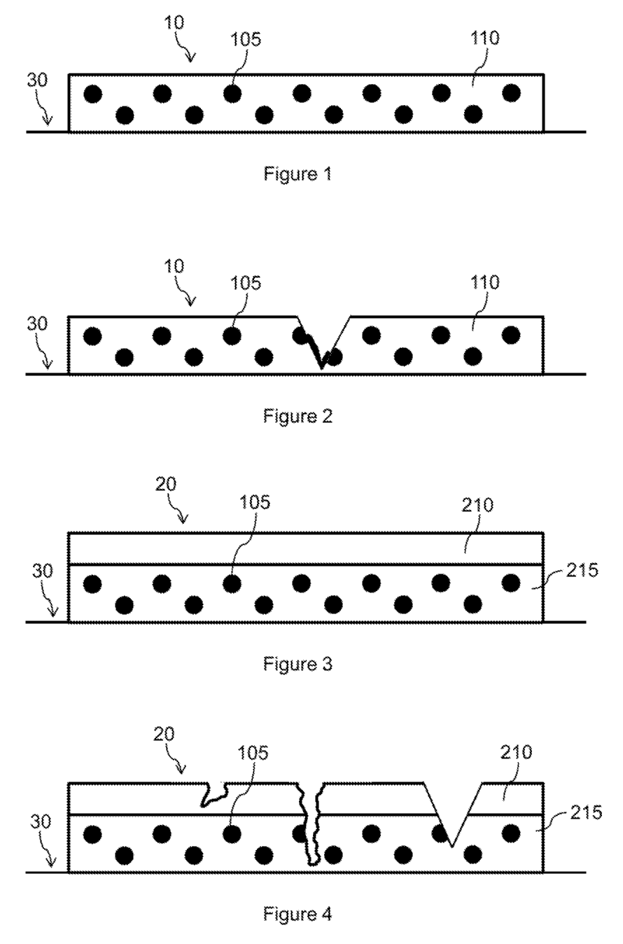

FIG. 1, which is not to scale, shows a schematic view of one aspect of the device 10 that is one subject of the presently disclosed embodiment. This coating 10 for inspecting the internal integrity of a structure 30, includes:

an optically active material 105 that is fastened against the structure 30; and

a coating matrix 110 associated with the optically active material 105 and configured to crack when said matrix 110 receives an impact at a preset pressure, the optically active material 105 being visible when such a crack is present.

The structure 30 is, for example, made of CFRP used instead of conventional metal structures. This structure 30 is, for example, a structure:

of an aircraft,

of a seagoing vessel,

of a land vehicle,

of a medical device, or

of a turbine.

Generally, the structure 30 may be any external body of a mechanical system or any structure forming a mechanism integratable into a larger mechanical system.

For example, the device 10 that is one subject of the presently disclosed embodiment may be used to detect an impact on:

a component of a ship, especially on the hull or mast, resulting from transport, mooring or movement of this ship;

a component of the engine, brakes, steering, clutch or braking system of an automotive vehicle;

a protective helmet;

a medical device;

a bicycle;

a pressure vessel, for example of a rocket launch vehicle;

the interior or exterior of such a vessel; or

a wind turbine component or blade.

The optically active material 105 is, for example, a nanostructured material. This nanostructured material may be organic or inorganic. This nanostructured material may be inorganic and porous. This nanostructured material may be formed from organic, luminescent, porous nanoparticles filled with fluorescent organic dye(s). This optically active material 105 is for example chosen for its ability to emit light signals (luminescence) under excitation by an exterior ultraviolet light source of wavelength comprised between 400 and 550 nanometers and preferably between 254 and 365 nanometers. Preferably, the optically active material 105 is chosen for its ability to emit light signals under excitation by an ultraviolet lamp of a wavelength of 254 nanometers. This optically active material 105 is for example SiNC-UMB (“silica nanocapsule containing umbelliferone”).

The coating matrix 110 is for example formed from at least one hybrid organic-inorganic metal organo-alkoxide precursor to form a sol-gel network. This precursor is, for example, tetraethoxysilane (abbreviated “TEOS”) making the matrix 110 more fragile and brittle. Alternatively, this matrix 110 is formed from dimethyldiethoxysilane (abbreviated DMDES) softening the matrix 110. Alternatively, this precursor is formed from (3-Glycidyloxypropyl)trimethoxysilane (abbreviated “GLYMO”), from phenyltrimethoxysilane (abbreviated “PTMS”) or hexadecyltrimethoxysilane (abbreviated “HDTMS”).

In variants, additives such as titanium dioxide or clay particles are added to the precursors.

The effect of the titanium dioxide is to block the intrinsic fluorescence of the filled nanoparticles.

The addition of clay increases the fragility of the matrix, thereby making it possible to determine the pressure at which the matrix 110 cracks depending on the amount of clay added to the composition of the matrix 110. The pressure required to crack the porous matrix is a decreasing function of the number of clay particles per unit volume in the matrix.

Preferably, between 1% and 10% of the weight of the matrix 110 is formed from clay particles. Preferably, 5% of the weight of the matrix 110 is formed from clay particles.

Thus, it will be understood that the pressure required to produce cracks depends on the composition of the matrix, this threshold being set to correspond to a minimum pressure liable to lead to the formation of internal damage in the structure 30.

FIG. 2 shows the device 10 after an impact on the matrix 110 has occurred, this impact having led to the creation of a crack in the matrix 110. The crack passes through the optically active material 105, and hence this material makes contact with free air. Depending on the variant, the material 105 either spreads or does not spread in the crack thus formed.

The material 105 thus becomes detectable outside of the matrix 110, thereby allowing an operator of the device 10 to identify the fact that the structure 30 has undergone an impact liable to have caused internal damage in the structure 30.

The optically active material 105 making contact with the free air is detected visually:

toollessly, when the optically active material 105 emits a light signal having a wavelength belonging to the light spectrum that is visible to the human eye;

using an emitter of ultraviolet light rays, the material 105 reacting to the contact of the ultraviolet light rays, the material 105 becoming optically active on contact with these ultraviolet rays to produce a light signal that is visible to the naked eye; or

using a chemical reactant, for example taking the form of an aerosol, which is applied to at least one crack, the material 105 reacting in contact with the chemical reactant, the material 105 becoming optically active on contact with this reactant to produce a light signal that is visible to the naked eye.

In variants, the optically active material 105 emits a light signal having a wavelength that is detected solely using an optical device that is configured to detect this wavelength and carried by the operator.

Once the impact has been detected, the operator may employ an ultrasonic device to inspect the structure 30 in order to check whether the structure 30 has sustained internal damage.

In aspects, such as that shown in FIGS. 1 and 2, the coating matrix 110 and the optically active material 105 are commingled. The matrix 110 and the material 105 are commingled in a single layer deposited on the structure 30.

In aspects, such as that shown in FIGS. 1 and 2, the optically active material 105 represents between 1% and 10% of the mass of the commingled matrix 110 and material 105.

Preferably, the optically active material 105 represents 5% of this weight.

In aspects, such as that shown in FIGS. 3 and 4, the coating matrix 210 is applied to a layer 215 including the optically active material 105, which is applied to the structure 30, the matrix 210 being fastened to an opposite side of this layer 215 with respect to the structure 30.

Preferably, the optically active material 105 is uniformly distributed in the layer 215.

The layer 215 for example has a thickness comprised between ten and fifty microns. Preferably, the thickness of the layer 215 is comprised between twenty and twenty-five microns.

The matrix 210 for example has a thickness of five to twenty microns. Preferably, the thickness of the layer 210 is close to ten microns.

Preferably, between 5% and 35% of the weight of the matrix 210 is formed from titanium. Preferably, 10% of the weight of the matrix 210 is formed from titanium.

In aspects, such as that shown in FIGS. 3 and 4, the nanoparticles are dispersed in a resin 215. This resin 215 is, for example, a polyepoxide, acrylic or polyurethane resin.

In aspects, such as that shown in FIGS. 3 and 4, the matrix 210 is opaque. By “opaque”, what is meant is non-transparent to at least one wavelength of the light signal emitted by the optically active material 105.

In aspects, such as that shown in FIGS. 1 to 4, the porous matrix, 110 or 210, is transparent to at least one wavelength of optical activity of the optically active material 105.

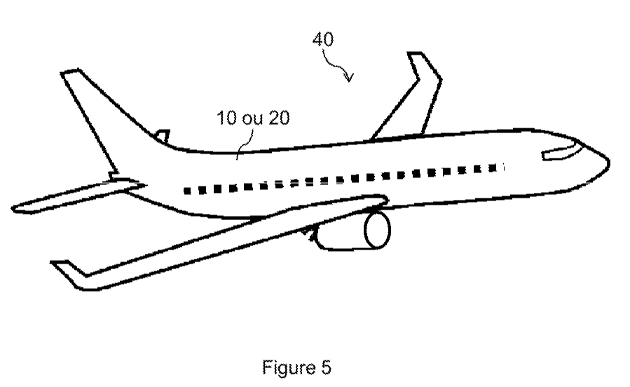

FIG. 5 schematically shows one aspect of the vehicle 40 that is one subject of the presently disclosed embodiment. Some of one structure 30 of this vehicle is covered with the device, 10 or 20, for inspecting the internal integrity of a structure, said device being such as described with regard to one of FIGS. 1 to 4.

What is claimed is:

1. A coating serving for inspection of the internal integrity of a structure, wherein it includes:
an optically active material; and
a matrix of the coating, which matrix is associated with the optically active material and configured to crack when said matrix receives an impact beyond a preset pressure, the optically active material being visible when such a crack is present.

2. The coating serving for inspection as claimed in claim 1, wherein the matrix of the coating and the optically active material are commingled.

3. The coating serving for inspection as claimed in claim 2, wherein the optically active material represents between 1% and 10% of the weight of the commingled matrix and material.

4. The coating serving for inspection as claimed in claim 1, wherein the matrix of the coating is applied to another layer incorporating the optically active material, which layer is applied directly to the structure, the matrix being fastened to an opposite side of this layer with respect to the structure.

5. The inspection coating as claimed in claim 1, wherein the matrix is opaque.

6. The inspection coating as claimed in claim 1, wherein the optically active material is formed from porous luminescent nanoparticles.

7. The inspection coating as claimed in claim 6, wherein the nanoparticles are dispersed in a resin.

8. The inspection coating as claimed in claim 1, wherein the optically active material is chosen to react to the exposure to ultraviolet rays, the optically active material becoming visible during such an exposure.

9. The inspection coating as claimed in claim 1, wherein the optically active material is chosen to react to the exposure to a chemical reaction, the optically active material becoming active during such an exposure.

10. The inspection coating as claimed in claim 1, wherein the matrix is formed from at least one hybrid organic-inorganic, metal organo-alkoxide precursor to form a sol-gel network.

11. The inspection coating as claimed in claim 10, wherein the porous matrix includes clay particles, the pressure required to crack the porous matrix being a decreasing function of the number of clay particles per unit volume in the matrix.

12. The inspection coating as claimed in claim 1, wherein the porous matrix is transparent at at least one wavelength of optical activity of the optically active material.

13. A vehicle, wherein some of a structure of this vehicle is covered with the device for inspecting the internal integrity of a structure as claimed in claim 1.
